(19) United States
(12) Patent Application Publication
(10) Pub. No.: US 2016/0083997 A1
(43) Pub. Date: Mar. 24, 2016

(54) ENHANCED POLARIZED PRIVACY WINDOW SYSTEM

(71) Applicant: Matthew Seamon, Winter Park, FL (US)

(72) Inventor: Matthew Seamon, Winter Park, FL (US)

(21) Appl. No.: 14/854,469

(22) Filed: Sep. 15, 2015

Related U.S. Application Data
(60) Provisional application No. 62/212,926, filed on Sep. 1, 2015.
(60) Provisional application No. 62/052,089, filed on Sep. 18, 2014.

(51) Int. Cl. E06B 9/24; G02B 27/28

(52) U.S. Cl. CPC E06B 9/24; G02B 27/281

(57) ABSTRACT

The invention proposed that one window pane have a polarized layer through which one looks at a window opposite which has a polarized layer with the polarization at a 90 degree angle to the first window's polarized layer. The result is that a person behind the first window cannot see through the opposite window. As with similar products currently available, this window tint system provides improved thermal and solar protection, and associated cost savings, throughout a wide range of applications by polarization.

### TECHNICAL FIELD

The invention relates to an enhanced polarized privacy window tinting system for homes, businesses, and recreational vehicles.

### BACKGROUND

Window with a polarized layer are known in the art. What is not known is a system of cooperating between windows by implementing a polarized aspect to a window in cooperation with another similarly modified window in order to achieve superior glare reduction and exceptional night-time and daylight privacy features not available in other products. Currently available privacy films rely on a reflective finish to restrict visibility into the home, business or vehicle. This methodology is only effective during daylight hours or with ample external lighting. Present solutions to the problem including so called one-way glass are dependent on there being relatively brighter light on side being observed so the glass appears reflective. If the light is brighter on one side of the window originally intended to be the discreetly observing side, there is no privacy for the observer on the better-lit side of the window.

### SUMMARY OF INVENTION

### Technical Problem

The technical problem is how to prevent a person in one building from looking through another building's window and seeing the activities inside, which each person inside each respective building can see outside his or her building relatively transparently.

### Solution to Problem

The invention proposed that one window pane have a polarized layer through which one looks at a window opposite which has a polarized layer with the polarization at a 90 degree angle to the first window's polarized layer. The result is that a person behind the first window cannot see through the opposite window. As with similar products currently available, this window tint system provides improved thermal and solar protection, and associated cost savings, throughout a wide range of applications by polarization.

### Advantages Effects of the Invention

The unique aspect of this window tinting system is that by implementing a polarized aspect to the treatment in cooperation with another similarly modified window arranged in coordination with the polarized aspect of the first window, one can achieve superior glare reduction and exceptional night-time and daylight privacy features not available in other products. Through the coordinated application of this system between adjacent structures or vehicles, light transmission between the interiors of these structures or vehicles is reduced to near zero levels. This masking provides a uniquely increased level of personal privacy. The polarizing feature of this product allows the outside view to remain effectively unobstructed, while only the internal features of the adjoining structure are blocked. Currently available privacy films rely on a reflective finish to restrict visibility into the home, business or vehicle. This methodology is only effective during daylight hours or with ample external lighting. The enhanced polarized system provides a level of privacy during a night-time, inside lighting environment, which cannot be obtained with conventional window tinting.

### BRIEF DESCRIPTION OF DRAWINGS—FIGURES

FIG. 1 is a view of a treated window with an exploded image detailing a potential polarization Orientation.

FIG. 2a is a view of dual pane application installed during manufacturing.

FIG. 2b is a view of a single pane or aftermarket external or internal application

FIG. 3 is a depiction of the polarization orientation between adjacent windows

FIG. 4 is a depiction of the polarization orientation between adjacent structures

### DRAWINGS—REFERENCE NUMERALS

10—Treated window

12—Exploded view showing polarization

14—Window pane in dual pane window

16—Window pane in dual pane window

18—Polarizing layer

20—Window pane in a single pane or aftermarket application

22—Polarizing layer

24—Treated window

26—Exploded view showing polarization

28—Adjacent window

30—Exploded view showing polarization

32—Overlapping privacy area of very low or no light transmission-opacity indicated by the black corner

34—Treated window

36—Exploded view showing polarization

38—Treated window

40—Exploded view showing polarization

### DESCRIPTION OF EMBODIMENTS

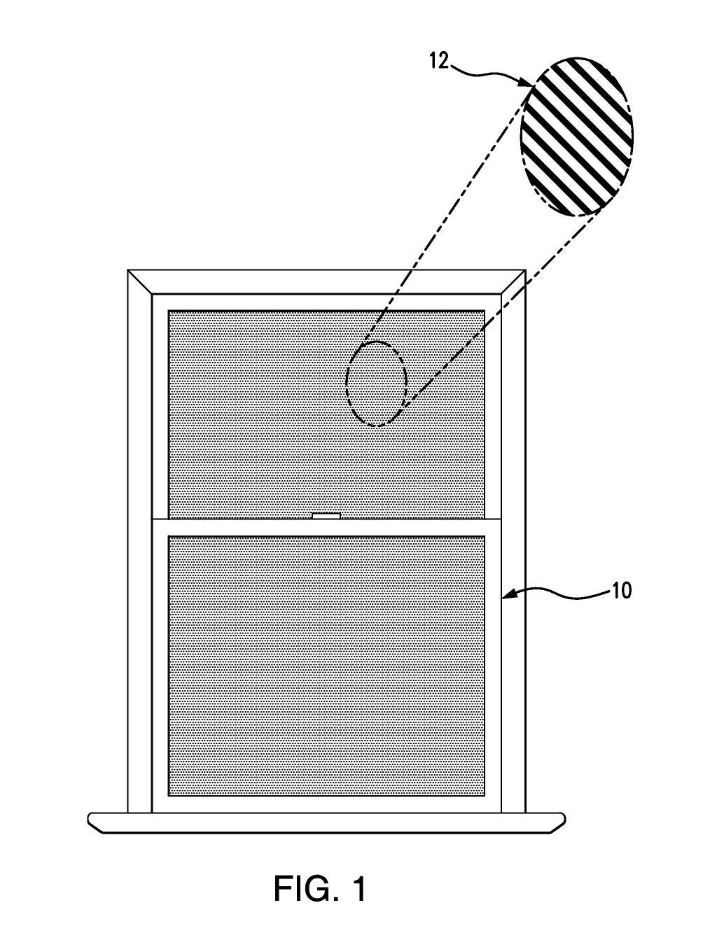

FIG. 1 shows window 10 which has been treated with an enhanced polarized privacy window tinting system as viewed from the inside. The window can be seen through; the grayscale shading is to show where the treatment has been applied. The orientation of the polarizing element is shown in exploded view 12. The polarizing element or film can be incorporated in one of two ways.

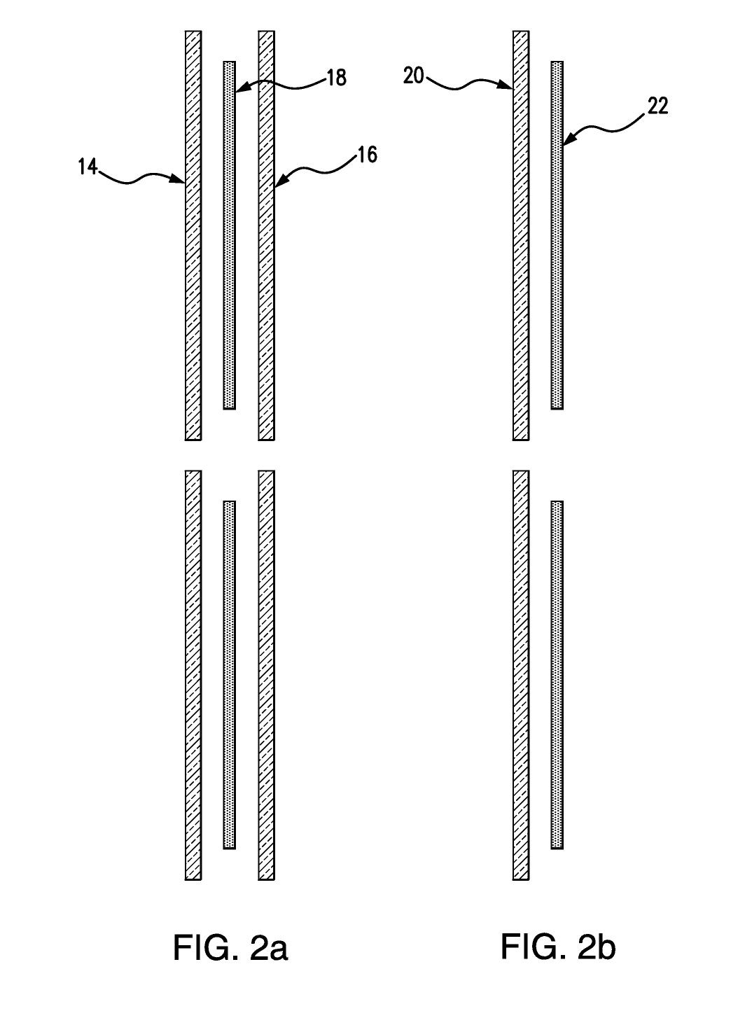

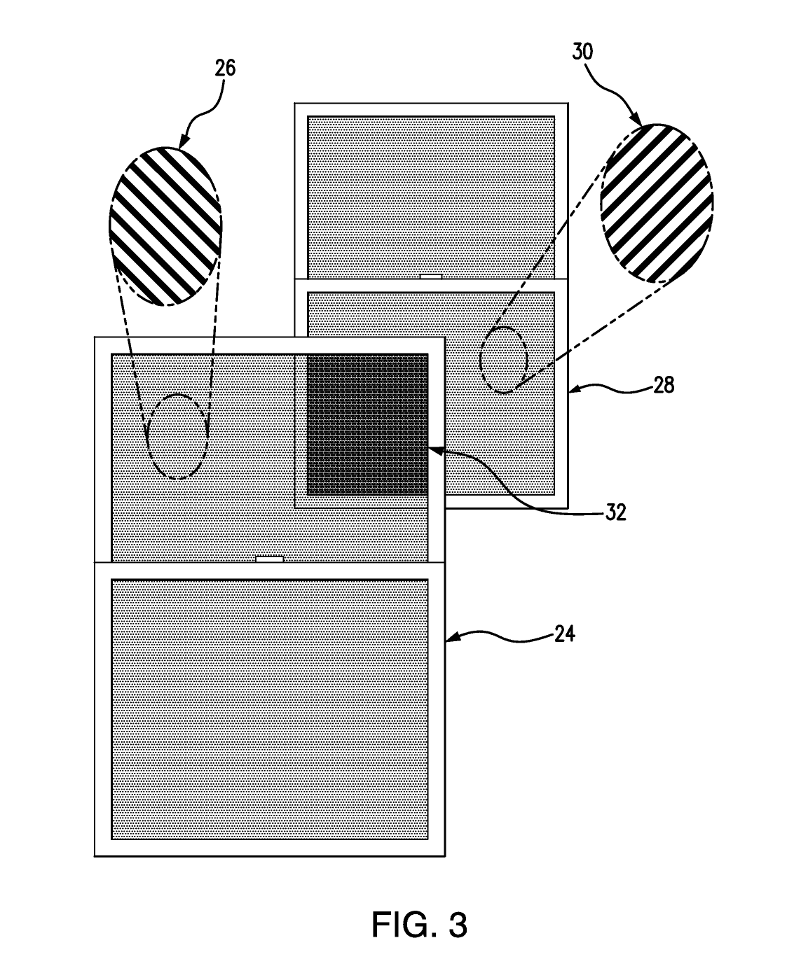

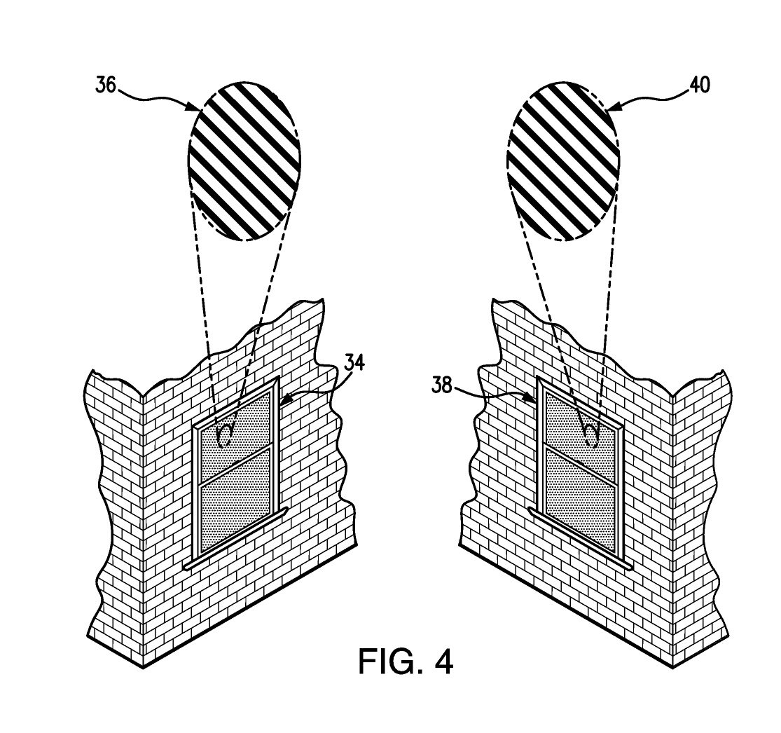

During manufacture of a multi-pane double hung type window as in FIG. 2a, the polarizing layer 18 is applied between window pane 14 and window pane 16 during manufacturing. More expensively, the glass can be manufactured with the polarization in the glass. For a single-pane window or in the case of an after-market installation as in FIG. 2b, the polarizing layer 22 is applied on the inside of window pane 20. Alternatively, the layer can be applied on the outside of the window. In FIG. 3, the polarizing axis 26 of window 24 is aligned so that its polarization orientation is perpendicular to the polarization orientation 30 of the adjacent facing window 28 resulting in an opaque view through the shown, illustrative corner to the corresponding corner of the opposite window 28. FIG. 4 shows oblique view of two facing walls having window (34 and 38) according to the invention.

Implementation

Polarizing film only allows light oriented in a specific direction to pass through. The enhanced polarized privacy window system insures that opposing windows of adjacent buildings or vehicles have similar polarizing windows 24 and 28 in FIG. 3, but with a polarization axis that is rotated 90 degrees between adjacent facing windows. Once window 24 and window 28 are properly treated and installed, each will appear to function in a manner similar to currently available window tinting with regard to external scenery. However, when looking out through window 24 and in through window 28, little to no light will pass through both surfaces as shown in ref 32, effectively blocking the view inside.

A preferred method to achieve the 90 degree angular rotation is to angle the polarization on each window at the same 45 degree angle, when viewed from the inside, as demonstrated in FIG. 4, Ref 36 and 40. This insures that a person on the inside of window 34 will be effectively unable to see in through the adjacent, opposing window 38. Different polarization alignments are suitable provided they preserve the 90 degree angle between the polarization axes of windows 34 and 38. A manufacturing advantage of a 45 degree orientation that all windows that are made the same and installed in adjacent buildings in the same manner on the exterior of a room, when facing each other, accomplish the invention of obscuring interior to interior views between structures while preserving exterior views from the interior of a room or building.

### ALTERNATIVE APPLICATIONS

The inventor of the enhanced polarized privacy window system recognizes alternative methods of embodying his invention as described below.

Although typical housing windows are depicted herein, this system is applicable to many residential applications including, but not limited to, external sliding and French doors.

Internal household uses might include shower doors or other areas where privacy is required or desired.

Commercial uses might include adjacent office buildings such as in the case of a hotel, lodging, or other commercial facility configured such that rooms or office spaces face each other. A proposed designated vertical orientation is simply to keep track of the relative direction of the polarization, but the window can be wider horizontally than vertically if the user so chooses.

The same principles can be applied to recreational vehicles. Recreational vehicles can include, but not limited to, boats, RVs, and motor coaches.

Another application is in a commercial or residential application to prevent viewing of a computer screen or other display through an exterior or interior window or partition. A polarized filter would be installed directly to the computer screen or display, or placed over it, in conjunction with a 90 degree displaced polarization layer on an adjacent window or partition, effectively blocking the screen or display when viewed through the adjacent window or partition.

Although the attached drawings indicate a 45 degree axis orientation for the polarizing treatment, any orientation will provide the same results as long as the 90 degree offset is preserved from one window, or opening through which perception is being made, to the next window or opening.

I claim:

1. A window tint system with enhanced privacy, thermal and solar protection, comprising:
Two facing transparent window panes in any one of a home, an office building or recreational vehicle or vessel;
each of said panes having a polarized layer, and each said layer having a polarization orientation;
said polarized layer being disposed on the first of said panes;
said polarized layer on the second of said window panes being disposed so that the polarization orientation on said second of said window panes is oriented 90 degrees from the polarization orientation of said first of said panes.

2. The window tint system according to claim 1, further comprising:
said first of said panes having a proposed vertical orientation, and said second of said panes having a proposed vertical orientation;
said polarized layer being disposed on said first of said panes with a polarization orientation at a 45 degree angle to said proposed vertical orientation, with the result that the polarized layer on the second of said window panes being disposed 90 degrees to the polarization orientation on said first pane orientation results in minimal light transmission through said two panes as well as providing solar and thermal protection in each of said individual panes.

3. A construction system for adjacent buildings to obscure the view from the interior of one building through its windows into another building through its windows:
at least one window of a first building;
at least one window of an adjacent second building;
each of said at least one windows having a polarized layer, and each said layer having a polarization orientation;
said polarized layer being disposed on said at least one window of the first building;
said polarized layer on said at least one window of said second building being disposed so that the polarization orientation on said at least one window of said second building is oriented 90 degrees from the polarization orientation of at least one window of the first building.

4. The construction system for adjacent buildings according to claim 1, further comprising:
both of said at least one window of said first building and said at least one window of said adjacent second building having a proposed designated vertical orientation;
said polarized layer being disposed similarly on each said at least one window of said first building with a polarization orientation at a 45 degree angle to said proposed designated vertical orientation of each said at least one window of said first building, with the result that the polarized layer on said at least one window of said adjacent second building being disposed 90 degrees to the polarization orientation on said each said at least one window of said first building orientation results in minimal light transmission through said windows as a person views the other building from within the viewer's building as well as providing solar and thermal protection in each of said windows having said polarized layer.
